(19) United States
(12) Patent Application Publication
(10) Pub. No.: US 2018/0189343 A1
(43) Pub. Date: Jul. 5, 2018

(54) NOTIFICATIONS SYSTEM FOR CONTENT COLLABORATIONS

(71) Applicant: Dropbox, Inc., San Francisco, CA (US)

(72) Inventors: Alexander Embiricos, San Francisco, CA (US); Larry Xu, San Francisco, CA (US); Sunny Rochiramani, San Francisco, CA (US); Tomaz Nedeljko, San Francisco, CA (US)

(21) Appl. No.: 15/395,912

(22) Filed: Dec. 30, 2016

(51) Int. Cl. G06F 17/30

(52) U.S. Cl. CPC G06F 17/30368

(57) ABSTRACT

In some embodiments, a content management system can monitor events generated by client devices and associated with user accounts registered at the content management system, and determine notification triggering rules corresponding to the user accounts. The content management system can identify one or more events that satisfy a respective notification triggering rule from the notification triggering rules, and correlate the respective notification triggering rule to a respective user account from the user accounts to yield a user account and triggering rule correlation. Based on the user account and triggering rule correlation, the content management system can generate one or more notifications for the one or more events and send the one or more notifications to at least one of the client devices associated with the respective user account.

### TECHNICAL FIELD

The present technology pertains to content notification systems.

### BACKGROUND

The increasing variety of software and computer tools available to users has drastically shaped the way users work, interact, and conduct business. In fact, today users rely on software and computer tools for almost every aspect of their work. For example, users often communicate through electronic mail or messaging systems, create and modify files and documents using specific software applications, manage schedules and events through calendar applications, and store and access data from their computing systems. This widespread adoption of software and computer tools by users and businesses has had a profound impact on cost, user efficiency, and user collaboration.

Unfortunately, the increase in collaboration between users and collaboration tools available to users have created unique computing challenges. For example, with a large number of collaboration events regularly taking place between users, it can be very difficult for users to track modifications to individual items and individual inputs from different users.

### BRIEF DESCRIPTION OF THE DRAWINGS

The above-recited and other advantages and features of the disclosure will become apparent by reference to specific embodiments thereof which are illustrated in the appended drawings. Understanding that these drawings depict only example embodiments of the disclosure and are not, therefore, to be considered to be limiting of its scope, the principles herein are described and explained with additional specificity and detail through the use of the accompanying drawings in which:

FIG. 1A illustrates an example system configuration of a content management system and client devices;

FIG. 1B illustrates a schematic diagram of an example notification system;

FIG. 2 illustrates an example of an interface for configuring notification settings for content items from a client device;

FIG. 3 illustrates example notification events for different user accounts in response to an event relating to a content item shared between the different user accounts;

FIG. 4A illustrates example notification list containing notifications generated for a user account;

FIG. 4B illustrates an example table of example events and corresponding notifications;

FIG. 4C illustrates a table of example coalesced notifications;

FIG. 5 illustrates example timetable of events and resulting notification activity for a user account;

FIG. 6 illustrates example graph for managing notifications for a user account;

FIG. 7A illustrates an example table of events which can be used to track events;

FIG. 7B illustrates an example table of notification rules and parameters;

FIG. 7C illustrates an example table of notifications;

FIG. 8 illustrates an example notification flowchart; and

FIG. 9 illustrates an example system embodiment.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for intelligent notification systems for computer collaboration tools, which can intelligently manage a high volume of collaboration events, including local events at different client devices, and support a wide variety of collaboration platforms and client devices. The approaches set forth herein can provide users intelligent and tailored notifications related to collaboration events and content items, and allow users to receive notifications on different devices and software applications. Moreover, the notification architectures and configurations described herein can significantly improve computer notification and collaboration technologies.

For example, notification systems described herein can monitor events both at a server side and a client side in order to increase the information about events and collaborations available for generating notifications to user devices. The notification systems can thus provide notifications to user devices relating to server events as well as local events generated by other users and client devices. Accordingly, users can receive at their local devices notifications about activity of different users and client devices, including both local and server activity, regardless of which client device and software applications are used to collaborate or access shared content items by users. This additional information about events and collaborations allows notification systems to better inform users and provide them greater collaboration insight and interconnectivity.

Additionally, despite having more information about events and collaborations available for generating notifications, the notification systems described herein can increase the user's focus and reduce the burden on users from excessive notification activity or information overload, by intelligently filtering notifications and information for the user. Each client device and user can benefit from an efficient, customized and connected collaboration and notification environment that crosses boundaries with respect to client devices, software applications, event origination, user accounts, content type, and so forth.

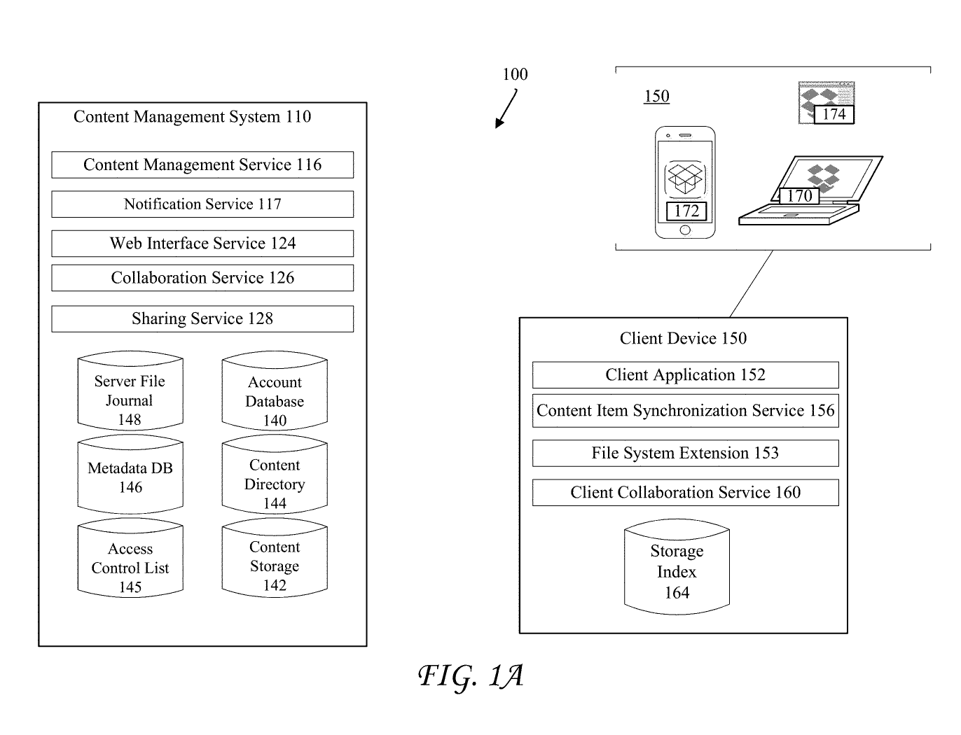

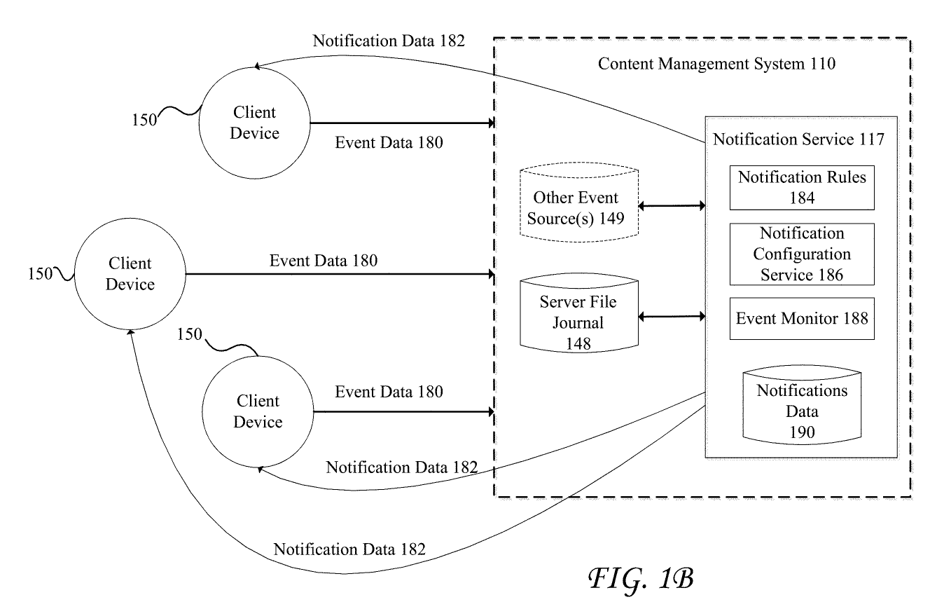

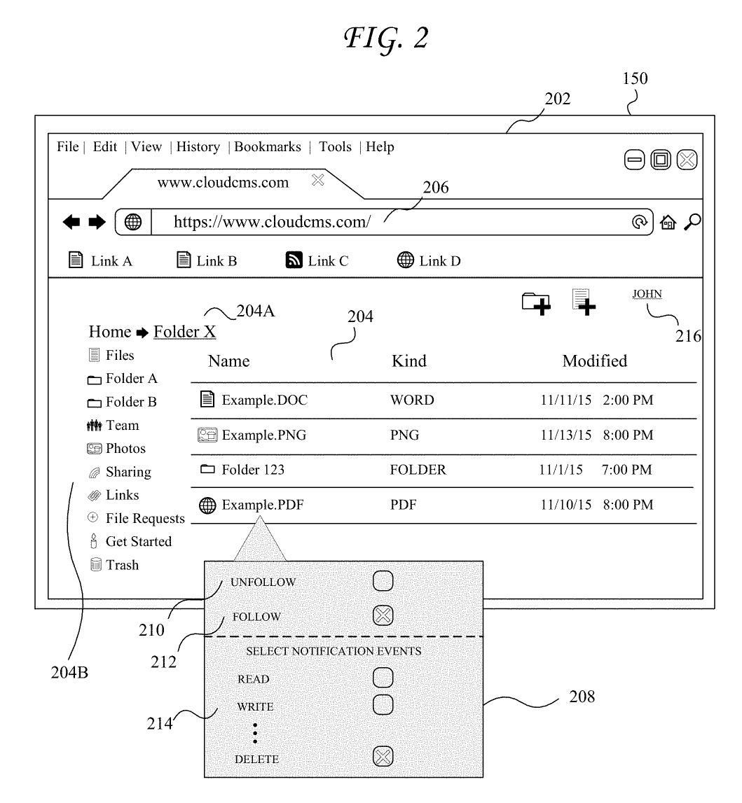

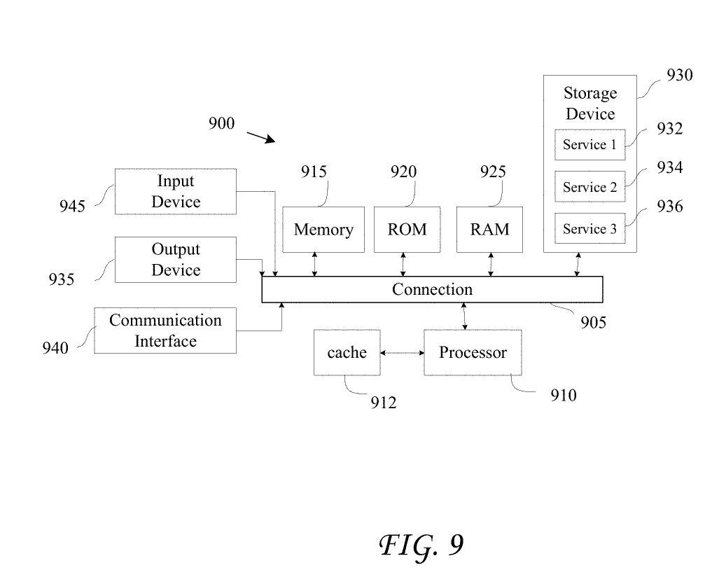

Disclosed are technologies that provide server-based notification architectures and environments for collaboration tools, and improve notification intelligence as well as device and application interoperability to effectively support cross-platform, cross-device, and high-volume environments. The disclosure begins with a discussion of example architectures and environments for collaboration and content notifications, as shown in FIGS. 1A and 1B. A more detailed description of notification technologies as shown in FIGS. 2-8, including various examples and configurations of notification systems, will then follow. The disclosure concludes with a description of example systems and devices for collaboration and content notifications, as shown in FIG. 9. The disclosure now turns to FIG. 1A.

In some embodiments the disclosed technology is deployed in the context of a content management system having content item synchronization capabilities and collaboration features, among others. An example system configuration 100 is shown in FIG. 1A, which depicts content management system 110 interacting with client device 150.

Accounts

Content management system 110 can store content items in association with accounts, as well as perform a variety of content item management tasks, such as retrieve, modify, browse, and/or share the content item(s). Furthermore, content management system 110 can enable an account to access content item(s) from multiple client devices.

Content management system 110 supports a plurality of accounts. An entity (user, group of users, company, etc.) can create an account with content management system, and account details can be stored in account database 145. Account database 140 can store profile information for registered entities. In some cases, profile information for registered entities includes a username and/or email address. Account database 140 can include account management information, such as account type (e.g. various tiers of free or paid accounts), storage space allocated, storage space used, client devices 150 having a registered content management client application 152 resident thereon, security settings, personal configuration settings, etc.

Account database 140 can store groups of accounts associated with an entity. Groups can have permissions based on group policies and/or access control lists, and members of the groups can inherit the permissions. For example, a marketing group can have access to one set of content items while an engineering group can have access to another set of content items. An administrator group can modify groups, modify user accounts, etc.

Content Item Storage

A feature of content management system 110 is the storage of content items, which can be stored in content storage 142. Content items can be any digital data such as documents, collaboration content items, text files, audio files, image files, video files, webpages, executable files, binary files, etc. A content item can also include collections or other mechanisms for grouping content items together with different behaviors, such as folders, zip files, playlists, albums, etc. A collection can refer to a folder, or a plurality of content items that are related or grouped by a common attribute. In some embodiments, content storage 142 is combined with other types of storage or databases to handle specific functions. Content storage 142 can store content items, while metadata regarding the content items can be stored in metadata database 146. Likewise, data regarding where a content item is stored in content storage 142 can be stored in content directory 144. Additionally, data regarding changes, access, etc. can be stored in server file journal 148. Each of the various storages/databases such as content storage 142, content directory 144, server file journal 148, and metadata database 146 can be comprised of more than one such storage or database and can be distributed over many devices and locations. Other configurations are also possible. For example, data from content storage 142, content directory 144, server file journal 148, and/or metadata database 146 may be combined into one or more content storages or databases or further segmented into additional content storages or databases. Thus, content management system 110 may include more or less storages and/or databases than shown in FIG. 1.

In some embodiments, content storage 142 is associated with at least one content management service 116, which includes software or other processor executable instructions for managing the storage of content items including, but not limited to, receiving content items for storage, preparing content items for storage, selecting a storage location for the content item, retrieving content items from storage, etc. In some embodiments, content management service 116 can divide a content item into smaller chunks for storage at content storage 142. The location of each chunk making up a content item can be recorded in content directory 144. Content directory 144 can include a content entry for each content item stored in content storage 142. The content entry can be associated with a unique ID, which identifies a content item.

In some embodiments, the unique ID, which identifies a content item in content directory 144, can be derived from a deterministic hash function. This method of deriving a unique ID for a content item can ensure that content item duplicates are recognized as such since the deterministic hash function will output the same identifier for every copy of the same content item, but will output a different identifier for a different content item. Using this methodology, content management service 116 can output a unique ID for each content item.

Content management service 116 can also designate or record a content path for a content item. The content path can include the name of the content item and/or folder hierarchy associated with the content item. For example, the content path can include a folder or path of folders in which the content item is stored in a local file system on a client device. Content management service 116 can use the content path to present the content items in the appropriate folder hierarchy, such as a tree-like directory structure. While content items are stored in content storage 142 in blocks and may not be stored under a tree like directory structure, such directory structure is a comfortable navigation structure for users Content management service 116 can define or record a content path for a content item wherein the “root” node of a directory structure can be a namespace for each account. Within the namespace can be a directory structure defined by a user of an account and/or content management service 116. Content directory 144 can store the content path for each content item as part of a content entry.

In some embodiments the namespace can include additional namespaces that appear in the directory structure as if they are stored within the root node. This can occur when an account has access to a shared collection. Shared collections can be assigned their own namespace within content management system 110. While shared collections are actually a root node for the shared collection, they are located subordinate to the user account namespace in the directory structure, and can appear as a folder within a folder for the user account. As addressed above, the directory structure is merely a comfortable navigation structure for users, but does not correlate to storage locations of content items in content storage 142.

While the directory structure in which an account views content items does not correlate to storage locations at content management system 110, the directory structure can correlate to storage locations on client device 150 depending on the file system used by client device 150.

As addressed above, a content entry in content directory 144 can also include the location of each chunk making up a content item. More specifically, the content entry can include content pointers that identify the location in content storage 142 of the chunks that make up the content item.

In addition to a content path and content pointer, a content entry in content directory 144 can also include a user account identifier that identifies the user account that has access to the content item and/or a group identifier that identifies a group with access to the content item. In some embodiments, multiple user account identifiers can be associated with a single content entry indicating that the content item has shared access by the multiple user accounts. In some embodiments, user account identifiers associated with a single content entry can specify different permissions for the associated content item. In some embodiments, content directory 144 can describe a hierarchical structure of content items associated with a user account, the hierarchical structure being specific to the user account.

Content management service 116 can decrease the amount of storage space required by identifying duplicate content items or duplicate blocks that make up a content item or versions of a content item. Instead of storing multiple copies, content storage 142 can store a single copy of the content item or block of the content item and content directory 144 can include a pointer or other mechanism to link the duplicates to the single copy.

Content management service 116 can also store metadata describing content items, content item types, folders, file path, and/or the relationship of content items to various accounts, collections, or groups in metadata database 146, in association with the unique ID of the content item.

Content management service 116 can also store a log of data regarding changes, access, etc. in server file journal 148. Server file journal 148 can include the unique ID of the content item and a description of the change or access action along with a time stamp or version number and any other relevant data. Server file journal 148 can also include pointers to blocks affected by the change or content item access. Content management service can provide the ability to undo operations, by using a content item version control that tracks changes to content items, different versions of content items (including diverging version trees), and a change history that can be acquired from the server file journal 148. The change history can include a set of changes that, when applied to the original content item version, produce the changed content item version.

Content Item Synchronization

Another feature of content management system 110 is synchronization of content items with at least one client device 150. Client device(s) can take different forms and have different capabilities. For example, client device 170 is a computing device having a local file system accessible by multiple applications resident thereon. Client device 172 is a computing device wherein content items are only accessible to a specific application or by permission given by the specific application, and the content items are stored either in an application specific space or in the cloud. Client device 174 is any client device accessing content management system 110 via a web browser and accessing content items via a web interface. While example client devices 170, 172, and 174 are depicted in form factors such as a laptop, mobile device, or web browser, it should be understood that the descriptions thereof are not limited to devices of these example form factors. For example a mobile device such as client 172 might have a local file system accessible by multiple applications resident thereon, or client 172 might access content management system 110 via a web browser. As such, the form factor should not be considered limiting when considering client 150's capabilities. One or more functions described herein with respect to client device 150 may or may not be available on every client device depending on the specific capabilities of the device—the file access model being one such capability.

In many embodiments, client devices are associated with an account of content management system 110, but in some embodiments client devices can access content items using shared links and do not require an account.

As noted above, some client devices can access content management system 110 using a web browser. However, client devices can also access content management system 110 using client application 152 stored and running on client device 150. Client application 152 can include a content item synchronization service 156.

Content item synchronization service 156 can be in communication with content management service 116 to synchronize changes to content items between client device 150 and content management system 110.

Client device 150 can synchronize content items with content management system 110 via content synchronization service 156. The synchronization can be platform agnostic. That is, content items can be synchronized across multiple client devices of varying type, capabilities, operating systems, etc. Content synchronization service 156 can synchronize any changes (new, deleted, modified, copied, or moved content items) to content items in a designated location of a file system of client device 150.

Content items can be synchronized from client device 150 to content management system 110, and vice versa. In embodiments wherein synchronization is from client device 150 to content management system 110, a user can manipulate content items directly from the file system of client device 150, while file system extension 156 (which can be integrated with the local file system, or even the operating system kernel) can intercept read, write, copy, move, delete commands relative to content items in the designated location of the file system of client device 150.

When file system extension 153 notices a write, move, copy, or delete command, it can notify content item synchronization service 156, which can synchronize the changes to content management system service 116. In some embodiments, content item synchronization service 156 can perform some functions of content management system service 116 including functions addressed above such as dividing the content item into blocks, hashing the content item to generate a unique identifier, etc. Content synchronization service 156 can index content items within client storage index 164 and save the result in storage index 164. Indexing can include creating a unique identifier for each content item. In some embodiments, content synchronization service 156 creates this unique identifier by putting the data of the content item (e.g., excluding the filename and/or other metadata) through a hash function; as addressed above, content management system can use a similar process to provide identifiers to content items on content management system 110. Content synchronization service 156 can use storage index 164 to facilitate the synchronization of at least a portion of the content items within client storage with content items associated with a user account on content management system 110. For example, content synchronization service 156 can compare storage index 164 with content management system 110 and detect differences between content items on client storage and content items associated with a user account on content management system 110. Content synchronization service 156 can then attempt to reconcile differences by uploading, downloading, modifying, and deleting content item(s) on client storage as appropriate. Content management service 116 can store the changed or new block for the content item and update server file journal 148, metadata database 146, content directory 144, content storage 142, account database 140, etc. as appropriate.

When synchronizing from content management system 110 to client device 150, a modification, addition, deletion, move of a content item recorded in server file journal 148 can trigger a notification to be sent to client device 150 using notification service 117. When client device 150 is informed of the change to server file journal 148, client device can check storage index 164 to determine if the time stamp of the change occurred since the last synchronization, or determine if the specific change has been synchronized. When client device 150 determines that it is out of synchronization with content management system 110, content item synchronization service 156 requests content item blocks including the changes, and updates its local copy of the changed content items. In some embodiments, notification service can query other services or databases of content management system 110 such as server file journal 148 to gain more context for the notification, to determine if a notification can be batched with another notification or to supplement a notification

Sometimes client device 150 might not have a network connection available. In this scenario, content item synchronization service 156 can monitor the linked collection for content item changes and queue those changes for later synchronization to content management system 110 when a network connection is available. Similarly, a user can manually start, stop, pause, or resume synchronization with content management system 110.

Content item synchronization service 156 can synchronize all content items associated with a particular user account on content management system 110. Alternatively, content item synchronization service 156 can selectively synchronize a portion of the content items associated with the particular user account on content management system 110. Selectively synchronizing only a portion of the content items can preserve space on client device 150 and save bandwidth.

In some embodiments, content item synchronization service 156 selectively stores a portion of the content item(s) associated with the particular user account and stores placeholder content items in client storage for the remainder portion of the content item(s). For example, content item synchronization service 156 can store a placeholder content item that has the same filename, path, extension, metadata, of its respective complete content item on content management system 110, but lacking the data of the complete content item. The placeholder content item can be a few kilobytes or less in size while the respective complete content item might be significantly larger. After client device 150 attempts to access the content item, content item synchronization service 156 can retrieve the data of the content item from content management system 110 and provide the complete content item to accessing client device 150. This approach can provide significant space and bandwidth savings while still providing full access to a user's content items on content management system 110.

Collaboration Features

Another feature of content management system 110 is to facilitate collaboration between users. Collaboration features include content item sharing, commenting on content items, co-working on content items, instant messaging, providing presence and seen state information regarding content items, etc.

Sharing

Content management system 110 can manage sharing content items via sharing service 128. Sharing content items by providing a link to the content items can include making the content items accessible from any computing device in network communication with content management system 110. However, in some embodiments a link can be associated with access restrictions enforced by content management system 110. Sharing content items can also include linking content items using sharing service 128 to share content items within content management system 110 with at least one additional user account (in addition to the original user account associated with the respective content item) so that each user account has access to the content item. The additional user account can gain access to the content by accepting the content item, which will then be accessible through either web interface service 124 or directly from within the directory structure associated with their account on client device 150. The sharing can be performed in a platform agnostic manner. That is, the content item can be shared across multiple client devices 150 of varying type, capabilities, operating systems, etc. The content item can also be shared across varying types of user accounts.

To share a content item within content management system 110 sharing service 128 can add a user account identifier to a content entry in access control list database 145 associated with the content item, thus granting the added user account access to the content item. Sharing service 128 can also remove user account identifiers from a content entry to restrict a user account's access to the content item. Sharing service 128 can record content item identifiers, user account identifiers given access to a content item, and access levels in access control list database 145.

To share content items outside of content management system 110, sharing service 128 can generate a custom network address, such as a uniform resource locator (URL), which allows any web browser to access the content item or collection in content management system 110 without any authentication. To accomplish this, sharing service 128 can include content identification data in the generated URL, which can later be used to properly identify and return the requested content item. For example, sharing service 128 can include the account identifier and the content path or a content item identifying code in the generated URL. Upon selection of the URL, the content identification data included in the URL can be transmitted to content management system 110, which can use the received content identification data to identify the appropriate content item and return the content item.

In addition to generating the URL, sharing service 128 can also be configured to record in access control list database 145 that a URL to the content item has been created. In some embodiments, the content entry associated with a content item can include a URL flag indicating whether a URL to the content item has been created. For example, the URL flag can be a Boolean value initially set to 0 or false to indicate that a URL to the content item has not been created. Sharing service 128 can change the value of the flag to 1 or true after generating a URL to the content item.

In some embodiments, sharing service 128 can associate a set of permissions to a URL for a content item. For example, if a user attempts to access the content item via the URL, sharing service 128 can provide a limited set of permissions for the content item. Examples of limited permissions include restrictions that the user cannot download the content item, save the content item, copy the content item, modify the content item, etc. In some embodiments, limited permissions include restrictions that only permit a content item to be accessed from within a specified domain, i.e., from within a corporate network domain, or by accounts associated with a specified domain, e.g., accounts associated with a company account (e.g., @acme.com).

In some embodiments, sharing service 128 can also be configured to deactivate a generated URL. For example, each content entry can also include a URL active flag indicating whether the content should be returned in response to a request from the generated URL. For example, sharing service 128 can only return a content item requested by a generated link if the URL active flag is set to 1 or true. Thus, access to a content item for which a URL has been generated can be easily restricted by changing the value of the URL active flag. This allows a user to restrict access to the shared content item without having to move the content item or delete the generated URL. Likewise, sharing service 128 can reactivate the URL by again changing the value of the URL active flag to 1 or true. A user can thus easily restore access to the content item without the need to generate a new URL.

In some embodiments, content management system 110 can designate a URL for uploading a content item. For example, a first user with a user account can request such a URL, provide the URL to a contributing user and the contributing user can upload a content item to the first user's user account using the URL.

Presence and Seen State

In some embodiments, content management system can provide information about how users with which a content item is shared are interacting or have interacted with the content item. In some embodiments, content management system 110 can report that a user with which a content item is shared is currently viewing the content item. For example, client collaboration service 160 can notify notifications service 117 when client device 150 is accessing the content item. Notifications service 117 can then notify all client devices of other users having access to the same content item of the presence of the user of client device 150 with respect to the content item.

In some embodiments, content management system 110 can report a history of user interaction with a shared content item. Collaboration service 126 can query data sources such as metadata database 146 and server file journal 148 to determine that a user has saved the content item, that a user has yet to view the content item, etc., and disseminate this status information using notification service 117 to other users so that they can know who currently is or has viewed or modified the content item.

Collaboration service 126 can facilitate comments associated with content, even if a content item does not natively support commenting functionality. Such comments can be stored in metadata database 146.

Collaboration service 126 can originate and transmit notifications for users. For example, a user can mention another user in a comment and collaboration service 126 can send a notification to that user that he has been mentioned in the comment. Various other content item events can trigger notifications, including deleting a content item, sharing a content item, etc.

Collaboration service 126 can provide a messaging platform whereby users can send and receive instant messages, voice calls, emails, etc.

Collaboration Content Items

Collaboration service 126 can also provide an interactive content item collaboration platform whereby users can simultaneously create collaboration content items, comment in the collaboration content items, and manage tasks within the collaboration content items. Collaboration content items can be files that users can create and edit using a collaboration content item editor, and can contain collaboration content item elements. Collaboration content item elements may include a collaboration content item identifier, one or more author identifiers, collaboration content item text, collaboration content item attributes, interaction information, comments, sharing users, etc. Collaboration content item elements can be stored as database entities, which allows for searching and retrieving the collaboration content items. Multiple users may access, view, edit, and collaborate on collaboration content items at the same time or at different times. In some embodiments this can be managed by requiring two users access a content item through a web interface and there they can work on the same copy of the content item at the same time.

Collaboration Companion Interface.

In some embodiments client collaboration service 160 can provide a native application companion interface for the purpose of displaying information relevant to a content item being presented on client device 150. In embodiments wherein a content item is accessed by a native application stored and executed on client device 150, where the content item is in a designated location of the file system of client device 150 such that the content item is managed by content application 152, the native application may not provide any native way to display the above addressed collaboration data. In such embodiments, client collaboration service 160 can detect that a user has opened a content item, and can provide an overlay with additional information for the content item, such as collaboration data. For example, the additional information can include comments for the content item, status of the content item, activity of other users previously or currently viewing the content item. Such an overlay can warn a user that changes might be lost because another user is currently editing the content item.

In some embodiments, one or more of the services or storages/databases discussed above can be accessed using public or private application programming interfaces.

Certain software applications can access content storage 142 via an API on behalf of a user. For example, a software package such as an application running on client device 150, can programmatically make API calls directly to content management system 110 when a user provides authentication credentials, to read, write, create, delete, share, or otherwise manipulate content.

A user can view or manipulate content stored in a user account via a web interface generated and served by web interface service 124. For example, the user can navigate in a web browser to a web address provided by content management system 110. Changes or updates to content in the content storage 160 made through the web interface, such as uploading a new version of a content item, can be propagated back to other client devices associated with the user's account. For example, multiple client devices, each with their own client software, can be associated with a single account and content items in the account can be synchronized between each of the multiple client devices.

Client device 150 can connect to content management system 110 on behalf of a user. A user can directly interact with client device 150, for example when client device 150 is a desktop or laptop computer, phone, television, internet-of-things device, etc. Alternatively or additionally, client device 150 can act on behalf of the user without the user having physical access to client device 150, for example when client device 150 is a server.

Some features of client device 150 are enabled by an application installed on client device 150. In some embodiments, the application can include a content management system specific component. For example, the content management system specific component can be a stand-alone application 152, one or more application plug-ins, and/or a browser extension. However, the user can also interact with content management system 110 via a third-party application, such as a web browser, that resides on client device 150 and is configured to communicate with content management system 110. In various implementations, the client-side application 152 can present a user interface (UI) for a user to interact with content management system 110. For example, the user can interact with the content management system 110 via file system extension 153 integrated with the file system or via a webpage displayed using a web browser application.

In some embodiments, client application 152 can be configured to manage and synchronize content for more than one account of content management system 110. In such embodiments client application 152 can remain logged into multiple accounts and provide normal services for the multiple accounts. In some embodiments, each account can appear as folder in a file system, and all content items within that folder can be synchronized with content management system 110. In some embodiments, client application 152 can include a selector to choose one of the multiple accounts to be the primary account or default account.

While content management system 110 is presented with specific components, it should be understood by one skilled in the art, that the architectural configuration of system 100 is simply one possible configuration and that other configurations with more or fewer components are possible. Further, a service can have more or less functionality, even including functionality described as being with another service. Moreover, features described herein with respect to an embodiment can be combined with features described with respect to another embodiment.

While system 100 is presented with specific components, it should be understood by one skilled in the art, that the architectural configuration of system 100 is simply one possible configuration and that other configurations with more or fewer components are possible.

FIG. 1B illustrates a schematic diagram of an example notification system. Each client device 150 can monitor events generated by the respective client device, and report event data 180 to content management system 110. For example, client application 152 can be configured to monitor events at client device 150 and report event data 180 to content management system 110 based on the events detected by client application 152 at client device 150. To illustrate, client application 152 can monitor or intercept system calls between user space and kernel space at client device 150 to identify events at client device 150 and send this information to content management system 110 in event data 180.

The events can include user and content activity, such as content item operations, user communications, user and/or process activity, etc. For example, events can include a user at client device 150 opening a content item, closing a content item, editing a content item, sharing a content item, synchronizing a content item, deleting a content item, renaming a content item, ending a content or collaboration session, moving a content item, generating a link to a content item, etc. The content item in this example can be locally stored at client device 150, but may also be stored at, and/or synchronized with, content management system 110. The content item can also be content accessed at client device 150 using a user account registered at content management system 110.

Event data 180 can include events captured at each client device 150, as well as other information associated with the detected events, such as user identifiers associated with the events; timestamp information for the events; device information, such as a device identifier corresponding to the respective client device; content information associated with an event, such as a file, content item, and/or content item identifier involved in the event or affected by the event; user account information; a process identifier associated with an event; content item metadata; etc. Event data 180 can also include event identifiers to allow content management system 110 identify the reported events in event data 180, and map the events to other corresponding information. For example, event data 180 can include an event identifier which identifies the event and/or the type of event, and can be mapped to other associated information in event data 180, such as a user or process identifier, a content item identifier, a timestamp, etc.

Content management system 110 can collect event information from event data 180, and send notification data 182 to each client device 150 as further explained below. Notification data 182 can include one or more notification messages, notification instructions, notification signals, notification settings, etc. Notification service 117 in content management system 110 can generate and/or send notification data 182, and manage notifications for each client device 150. Notification data 182 can be sent to, or presented at, client application 152 on client device 150 and/or other applications on client device 150, such as a browser application for browsing Internet content (e.g., web pages and websites).

Notification service 117 can include notification rules 184, which can provide instructions for generating notifications, including when to generate notifications, how to generate notifications, what type of notifications to generate, when to send the notifications, etc. For example, notification rules 184 can define notification triggering events or conditions, such as file or folder operations; types of notifications, such as popup messages, badge alerts, tray notifications, updates to current notifications, etc.; notification selection logic, which can provide instructions for determining which types of notification(s) should be sent according to a given context, triggering event, status, user account, preferences, and so forth.

Notification rules 184 can be based on user account preferences, device preferences, machine learning logic, and other rules or algorithms. Moreover, notification rules 184 can vary based on one or more factors, such as user account preferences, timing preferences, content preferences, notification statistics, notification history information, notification graphs, etc.

Notification service 117 can also include notification configuration service 186. Notification configuration service 186 can include instructions, preferences, rules, etc., defining the presentation configuration for notifications, such as the visual appearance or characteristics of notifications, the presentation style or type for the notifications, presentation form and location, presentation frequency, etc. For example, notification configuration service 186 can define where to present a notification within a graphical user interface (e.g., tray, popup window, notification list, banner, top of screen, bottom of screen, etc.), whether the notification should be provided by updating a current notification or generating a new notification, the size and shape of the notification (e.g., small notification message, large popup window, etc.), and other presentation criteria and characteristics.

Event monitor 188 can monitor events and operations reported in event data 180 to allow notification service 117 to identify a triggering event and initiate a notification action. For example, event monitor 188 can periodically query server file journal 148, as well as other event source(s) 149, to identify events detected or reported by a client device. Event monitor 188 can be configured to obtain event information from server file journal 148 and other event source(s) 149 on a push and/or pull basis. For example, event monitor 188 can query (i.e., pull) for new events and/or receive new events reported (i.e., pushed) to event monitor 188.

Notifications data 190 can store notifications data 182 sent to each client device 150. Notifications data 190 can maintain records of notifications sent to each client device 150, notification statistics, event information, etc. For example, notifications data 190 can store metadata about notifications sent and/or a copy of notifications sent. This information can help notification service 117 track notifications and notifications statistics, and can be used when generating new notifications or updated notifications. For example, notifications data 190 can help notification service 117 determine that a notification was previously sent to a user account for a particular event or content item, such as a shared file, which notification service 117 can then use to determine whether to send a new notification after a subsequent triggering event or instead update a current or previous notification or notification list associated with the particular user account. As another example, notifications data 190 can include information about a number of alerts associated with a user account, an order or priority of alerts, a frequency of alerts, etc., which can help notification service 117 determine status information, such as a status or count of an alert counter (e.g., notification counter as explained later).

FIG. 2 illustrates an example of a graphical user interface for configuring notification settings for content items from client device 150. Graphical user interface 202 can allow a user at client device 150 to access user account 216 in content management system 110 and content items related to user account 216, and interact with the content items as well as other user accounts at content management system 110. The content items, settings, permissions, features, presentation, etc., displayed on graphical user interface 202 can be specific to user account 216 authenticated with content management system 110. For example, the content items in content views 204 and 204A-B can be associated with user account 216.

However, in some cases, it is noted that graphical user interface 202 may not be specific to any user account, e.g., graphical user interface 202 may access content items in content management system 110 and present a similar graphical user interface even if no user account is authenticated with content management system 110. For the sake of clarity and explanation purposes, graphical user interface 202 and various features disclosed herein are described in the context of user accounts registered and/or authenticated with content management system 110, such as user account 216.

Graphical user interface 202 can be accessed via client application 152 as shown in FIG. 1A and/or a browser application, such as a web browser, at client device 150. In the example of FIG. 2, graphical user interface 202 is accessed via a browser application at client device 150. The browser application at client device 150 can access content items from content management system 110 through navigation toolbar 206, which can include a network address to a page, site, and/or content items hosted by content management system 110.

Graphical user interface 202 can include content views 204, 204A-B. Content view 204 can include content items available to user account 216, such as documents, folders, files, links, and any other type of content items. Content view 204 can include content items that are specific to user account 216 and/or shared with other user accounts. Shared content items in content view 204 can be similarly accessed by the other user accounts which have shared access to those content items.

Content view 204A can show a current navigation, folder, workspace, and/or content area being presented on interface 202. For example, content view 204A can indicate whether the content items in content view 204 reside in a root folder on content management system 110 associated with user account 216, or within a specific sub-folder, such as FolderX in a root folder for user account 216.

Graphic user interface 202 can present notifications settings view 208 to allow a user to configure specific notification preferences for one or more content items presented in content view 204. For example, a user can select a specific content item in content view 204, such as “Example.PDF”, and access notifications settings view 208 for that selected content item to configure specific notifications setting for that content item. The user can select the particular content item and access notifications settings view 208 for that content item in one or more different ways, such as, without limitation, right-clicking on the particular content item and selecting a notifications option presented for that particular content item upon right-clicking on the content item.

In some examples, notifications settings view 208 can include unfollow option 210 and follow option 212. When selected by a user, unfollow option 210 can allow the user to disable all notifications for the particular content item associated with notifications settings view 208. On the other hand, when selected by a user, follow option 212 allows a user to enable all notifications for the particular content item. Enabling all notifications can result in a notification being generated and presented to user account 216 for every triggering event. For example, enabling all notifications can allow a user to receive notifications for all activity related to the particular content item, such as modifications or edits, delete events, add events, permission or membership events, comments, read events, unread events, follow or unfollow events, rename events, sharing events, open events, close events, view events, synchronization events, etc. Example notifications and conditions for some of these non-limiting events will be further described below.

Notifications settings view 208 can also include (i.e., in addition to or in lieu of, unfollow option 210 and follow option 212) individual notification options 214, which can allow a user to select or deselect individual events related to the particular content item, for which the user wishes to receive notifications. Non-limiting examples of events which can be included in individual notification options 214 are read events, write events (e.g., modification or edit events), delete events, permission or membership events, comments, unread events, follow or unfollow events, rename events, sharing events, open events, close events, synchronization events, move events, etc. Individual notification options 214 can thus give the user more granular control over when and how to receive notifications relating to the particular content item.

In some cases, individual notification options 214 can also include machine learning or intelligent predictive options, which allows the user to enable content management system 110 to intelligently make decisions on when and how to provide notifications to the user for the particular content item even without explicit instructions or preferences from that user. Content management system 110 can use hard-coded rules, machine learning algorithms, past user behavior, statistics, other user behavior, content relationships, user relationships, etc., to make intelligent decisions for when and how to provide a notification to the user.

Notification settings defined for a folder, container, or any other content item which has relationships to other items (e.g., relationships in a hierarchy, a tree, a dendrogram, etc.), can be propagated to other, related content items. For example, settings defined for a folder can be propagated to content items within the folder—although exceptions can be created for content items which otherwise have explicit settings from a user, as the explicit settings can override propagated settings.

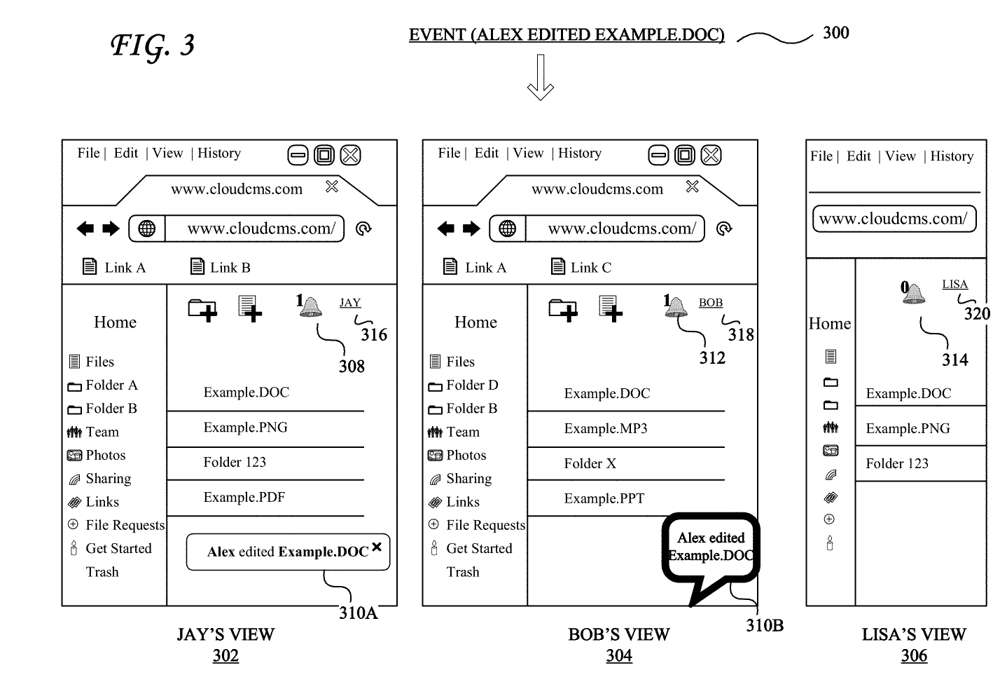

FIG. 3 illustrates example notification events for different user accounts in response to an event relating to a content item shared between the different user accounts. The notification events in this example can be based on different notification settings set for the content item for the different user accounts. The notification events are represented in view 302 for user account 316 associated with user Jay, view 304 for user account 318 associated with user Bob, and view 306 for user account 320 associated with user Lisa.

Views 302, 304, 306 can be based on event 300 associated with a content item shared by user accounts 316, 318, 320. For example, event 300 can be based on a user “Alex” having edited a file “Example.DOC” shared by user accounts 316, 318, 320. As previously noted, views 302, 304, 306 can vary based on different notification settings configured for event 300 and/or the associated file “Example.DOC” for user accounts 316, 318, 320.

In view 302, user account 316 can receive push notification 310A based on event 300, and a notification alert in notification icon 308. Push notification 310A can provide a log or description of event 300, which can include, without limitation, the user that generated event 300 (e.g., Alex), the content item associated with event 300 (e.g., “Example.DOC”), the operation or event associated with content item from event 300 (e.g., edit event), as well as other information, such as a timestamp, a link, a prompt (e.g., accept or deny prompts, etc.), etc. Notification 310 can also be selectable. For example, the user can select push notification 310A to open the corresponding content item (e.g., “Example.DOC”), establish a communication or discussion with the user associated with event 300 (e.g., Alex), etc.

Notification icon 308 can be, for example, a bell badge alert icon, which can notify user account 316 that a new notification has been received and/or an unread notification exists. Notification icon 308 can display a number of notifications available to user account 316, such as a number of unread and/or total notifications. When a new notification is sent to user account 316, a counter of notification icon 308 can be incremented, and notification icon 308 can thus display a number of additional notification(s).

In view 304, user account 318 may not receive a push notification, but may otherwise receive tray notification 312B and a notification alert in notification icon 312. Tray notification 312B can include a notification provided in a desktop tray area. Tray notification 312B can be automatically displayed with a notification message or may require user account 318 to select a corresponding icon or element in the desktop tray area. The type of notifications provided to a user account can depend on user account settings and/or other factors as further explained below.

In some cases, view 302 or view 304 may not include push notification 310A or tray notification 310B. For example, instead of providing a notification message to a user account, content management system 110 may instead provide a notification alert in notification icon 308 or 312 and allow the user to access a notification message from notification icon 308 or 312.

In some cases, content management system 110 can update a current notification message or list based on event 300, rather than providing a push notification 310A or tray notification 310B. The user can determine based on their notification icon that a notification has been updated and chose to review the updated notification when desired. For example, the user can access the updated notification or a notification list from notification icon 312 by selecting notification icon 312 to review notifications.

In view 306, user account 320 may not receive a push or tray notification message or a notification alert in notification icon 314. This can be based on a preference by user account 320 to not receive notifications for event 300, the content item associated with event 300, the operation associated with event 300, the user that generated the operation associated with event 300, etc. However, in some cases, user account 320 my still be notified about event 300 based on a notification update as further explained below.

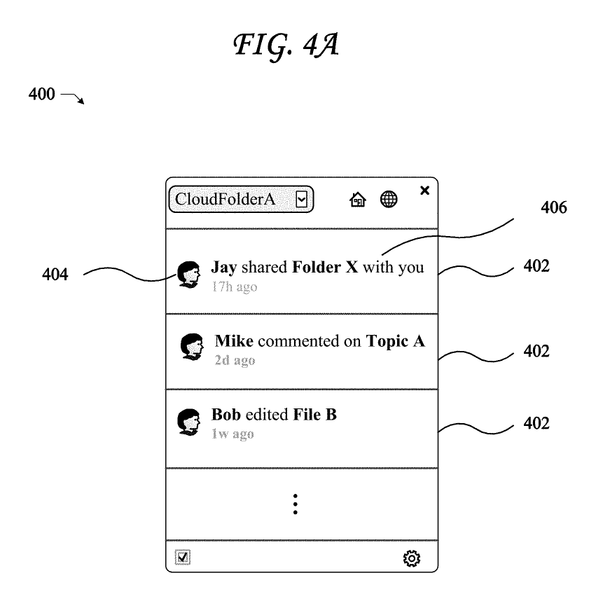

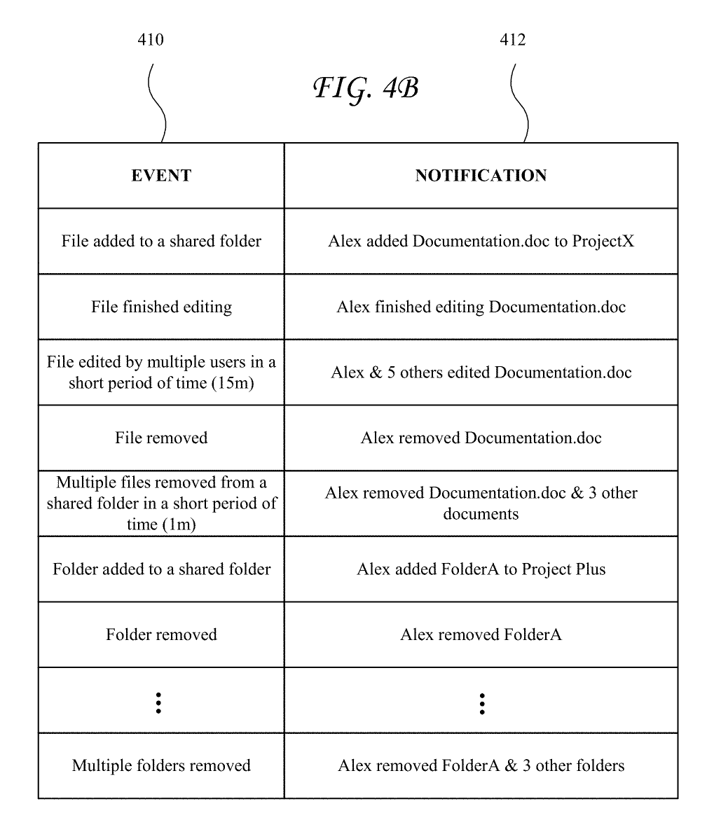

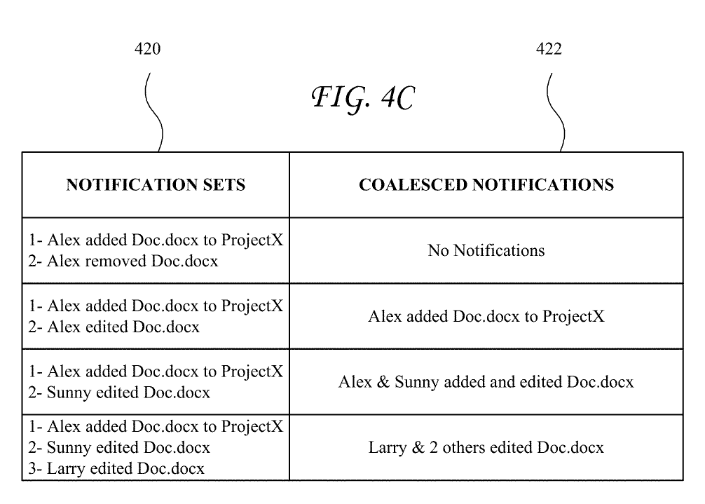

FIG. 4A illustrates example notification list 400 containing notifications 402 generated for a user account. Notification list 400 can be presented to the user as part of a message notification, in response to the user selecting a message notification such as notification 310A or 310B, in response to the user selecting a notification alert, such as notification icons 308, 312, 314, based on a user request, etc.

Notification list 400 can include notifications 402, which can include a number of notifications received by a user account. The number of notifications 402 in notification list 400 can include all notifications received by a user account or a subset of notifications received by the user account, such as notifications received within a predetermined period (e.g., one week), a predetermined number of the notifications received by the user account (e.g., 20 latest notifications), a number of notifications having one or more characteristics (e.g., a priority, a date, a user, a topic, a device, etc.), and so forth. Notifications 402 within notification list 400 can be prioritized, ordered, organized, edited, etc. For example, notifications 402 can be presented in notification list 400 according to a sorting parameter, such as a date, such that the latest notification is presented first or last.

Notifications 402 can include notification content 406, which can include a description of the event associated with the respective notification, information about the content item associated with the respective notification, a date of the event or notification, etc. Notifications 402 can also include user account representations 404, which can identify one or more user accounts associated with the respective notifications, such as the user account which generated the event associated with the respective notifications. For example, if the event associated with a notification is user account Bob editing a content item named “File B”, the notification can include a narrative or description in notification content 406 indicating that Bob edited File B, and a thumbnail or label associated with the user account Bob provided in a respective one of user account representations 404.

In some cases, some notifications 402 can be aged and removed from notification list 400. For example, a notification can be assigned an expiration threshold. The amount of time can be the same for all notifications 402 or may vary for different notifications 402 based on one or more factors, such as read status, preference data, topic, associated content item, associated user account(s), frequency of activity, etc. In some cases, one or more of notifications 402 can remain permanently on notification list 400 until a particular user event. For example, a notification may remain permanently in notification list 400 until the user manually removes the notification, reads the notifications, selects the notification, accesses the content item associated with the notification, etc.

Whether a notification remains in notification list 400 can be dependent on specific factors associated with the notification or can be configured as a default behavior for all notifications. For example, a notification can remain in notification list 400 beyond an aging period if the notification is determined to be a high priority notification, a recurring notification, associated with a particular content item or type of content item, associated with a particular user, or specifically designated by a user as a static notification that should remain on notification list 400 beyond a period of time.

In some cases, a notification may remain at the top of notification list 400 or within X number of notifications from the top. For example, a user account can configure a particular notification to remain within the top 5 notifications in notification list 400 to prevent the notification being buried below a large number of notifications. Content management system 110 can also maintain a notification within a range from the top of notification list 400 for a user account based on one or more factors, such as a priority, a topic associated with the notification, a user associated with the notification, a content item associated with the notification, etc.

FIG. 4B illustrates an example table of example events 410 and corresponding notifications 412. Events 410 include example events (e.g., operations, activities, etc.) which can trigger a notification. Notifications 412 include example notifications generated for events 410. For example, an example notification for an event in which a file is added to a shared folder can be “Alex added Documentation.doc to ProjectX”. This information can be provided as part of notification content 406 of the specific notification. Thus, the notification can specify the event or action (e.g., file added to shared folder), as well as specific details about the file (e.g., “Documentation.doc”), the user account that generated the event or action (e.g., Alex), and the shared folder (e.g., “Project X”).

A notification can also be generated for multiple events. For example, if multiple files are removed from a shared folder, a notification can be generated summarizing that multiple files have been removed. In some cases, notifications can also be merged or coalesced, summarized or condensed, etc.

Referring to FIG. 4C, coalesced notifications 422 can be determined from notification sets 420. Coalesced notifications 422 can include canceling a combination of notifications, ignoring one or more notifications in a combination of notification, or coalescing notifications into a single notification.

For example, the combined notifications that “Alex added Doc.docx to Project X” and “Alex removed Doc.docx” can be filtered so no notifications are provided if the notifications when combined cancel each other or if neither notification is set to be reported to the user account.

As another example, the notifications “Alex added Doc.docx to Project X” and “Alex edited Doc.docx” can be coalesced into a notification that “Alex added Doc.docx to Project X” in order to only report one of the two notifications. In another example, the notification “Alex added Doc.docx to Project X” and “Sunny edited Doc.docx” can be combined into a notification that “Alex & Sunny added and edited Doc.docx”.

Notifications can also be summarized into one notification. For example, notifications “Alex added Doc.docx to Project X”, “Sunny edited Doc.docx”, and “Larry edited Doc.docx” can be summarized into a single notification indicating “Larry & 2 others edited Doc.docx”.

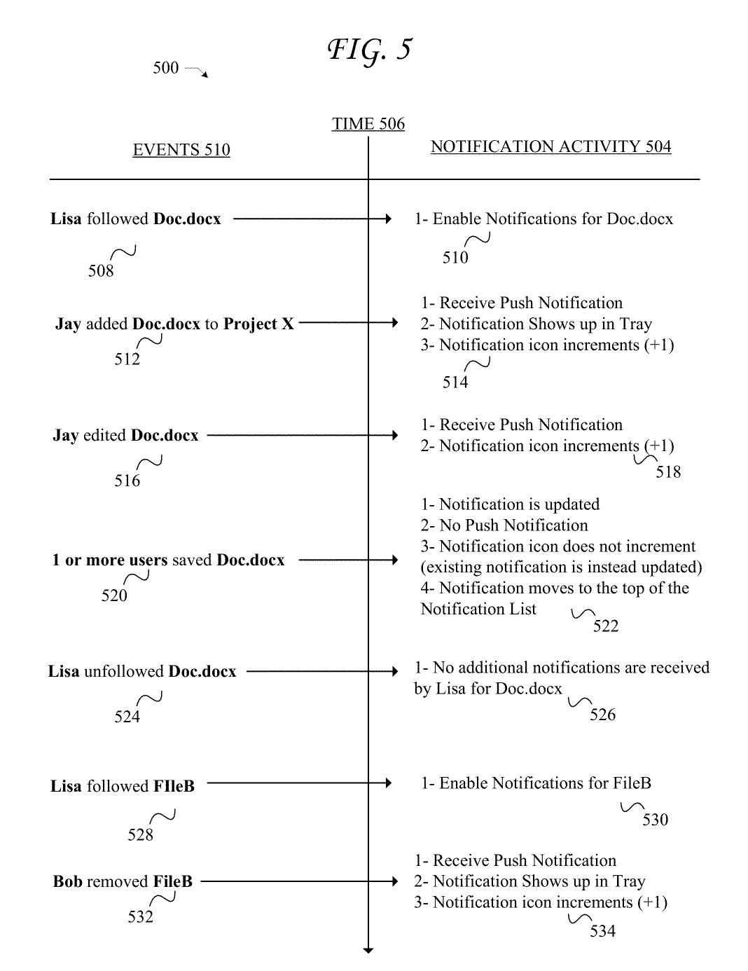

FIG. 5 illustrates example timetable 500 of events 510 and resulting notification activity 504 over time 506 for a user account. At event 508, when Lisa follows Doc.docx, notification event 510 can include enabling notifications of events related to Doc.docx for Lisa. At event 512, when Jay adds Doc.docx to Projec X, notification events 514 can include Lisa receiving a push notification (e.g., notification 310A) for Jay adding Doc.docx to Project X, a notification message or alert being displayed on a desktop tray for Lisa (e.g, tray notification 310B), and a notification icon (e.g., notification icon 308 shown in FIG. 3) on Lisa's account being incremented to show a new or unread notification.

At event 516, when Jay edits Doc.docx, notification event 518 can include Lisa receiving a push notification for Jay editing Doc.docx and a notification icon of Lisa being incremented to indicate a new or unread notification.

At event 520, when one or more users save Doc.docx, notification event 522 can include updating a current notification (e.g., updating notification content 406 and/or user account representation 404 for a corresponding notification) previously received by Lisa, with no push notification being received by Lisa and Lisa's notification icon not being incremented because a notification for Doc.docx was already received by Lisa. However, the updated notification can be moved to a top of Lisa's notification list (e.g., notification list 400) so Lisa knows the updated notification is the latest notification updated or received.

For example, a previous notification for Doc.docx on notification list 400 for Lisa can be updated to reflect the new event associated with Doc.docx, namely, one or more users having saved Doc.docx, without sending an entirely new notification for Doc.docx which would result in Lisa having multiple notifications for Doc.docx in her notification list 400. Thus, updated notifications can reduce the bandwidth and/or space consumed by notifications, may limit the number of notifications in the uses notification list, may reduce multiple notifications for a same content item, event, or user, and may have other benefits which can improve the computing and user experiences. In some cases, however, the user may select to receive new notifications instead of notification updates. In such cases, the user account may receive new or multiple notifications for a same content item (e.g., Doc.docx), event, user, etc. Thus, users can select whether to receive notification updates or treat every notification as a new notification.

One or more factors can also be used to configure when notification updates are received as opposed to when notifications are provided as new notifications. For example, notification updates can be set for any content items that the user has already received a notification for, or may be limited to a certain period of time, such as a week.

At event 524, when Lisa unfollows Doc.docx, notification event 526 can be that no additional notifications are received by Lisa for Doc.docx.

At event 528, when Lisa follows FileB, notification event 520 can include enabling notifications to Lisa for FileB. At event 532, when Bob then removes FileB, notification event 534 can include Lisa receiving a push notification that Bob has removed FileB, a notification alert or message being presented on a desktop tray for Lisa, and a notification icon for Lisa increments to indicate a new or unread notification.

Notification activity 504 illustrates different notification events or actions when a notification is a notification update and when the notification is a new notification. For example, in the examples from notification activity 504, a notification update can result in a current notification being updated (e.g., notification content or message updated for a current notification) and the notification being moved to a top of the notification list for that user (assuming the current notification is not already on the top of the notification list). By contrast, in the examples from notification activity 504, when a notification is a new notification, the resulting notification activity can include a push notification, a notification displayed in a desktop tray for the user account, and a notification icon being incremented. These example combinations of notification activity 504 and events 510, including the different scenarios for notification updates and new notifications, are provided as non-limiting examples for explanation purposes.

It is contemplated herein that notification updates and/or new notifications can have different configurations which vary the notification activity resulting from certain notifications and/or notification types. For example, in some scenarios, a new notification may result in a push notification with or without a tray notification and/or a notification icon being incremented. As another example, in some scenarios, a notification update can result in a push notification, a tray notification, and/or a notification icon being incremented.

Moreover, notification updates can be determined when a new notification or event has a commonality with a previous notification or event associated with a user account. For example, notification updates can be determined when a file associated with a new event or notification is also associated with a previous notification. To illustrate, a notification for an event relating to FileB can be treated as an updated notification when the user account already has a notification relating to FileB. The example commonality described here is a content item. However, other commonalities can also be used for determining notification updates, such as a commonality between user accounts, devices, dates, authors, topics, etc. For example, notification updates can be provided to a first user account for events related to a second user account when the first user account previously received a notification relating to the second user account, such that for events related to the second user account, the first user account will only receive notification updates.

In addition, notification updates can be based on a combination of factors. To illustrate, from the previous example, notification updates can be provided to the first user account for events related to the second user account and a content item when the first user account previously received a notification relating to both the second user account and the content item, such that for events related to both the second user account and the content item, the first user account only receives notification updates.

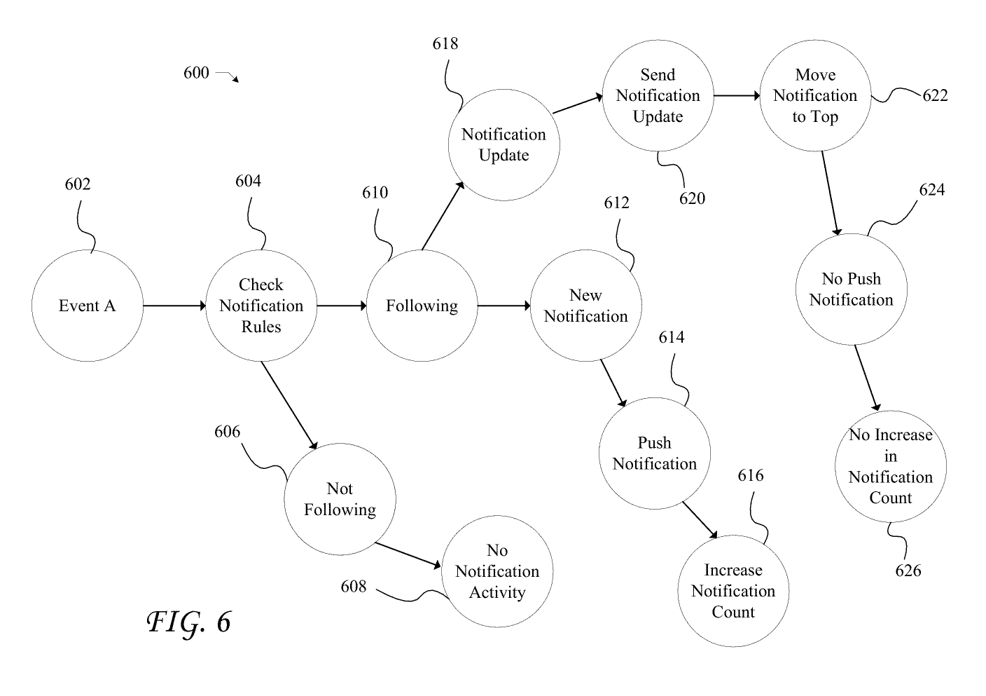

FIG. 6 illustrates example graph 600 for managing notifications for a user account. Graph 600 begins with node 602 which represents event A, and follows with node 604 for checking notification rules for event A. At node 606, the user account is not following the content item related to event A, and at node 608 no notification activity is generated.

At node 610, the user account is following the content item associated with event A and/or event A. At node 612, a new notification should be generated for event A. Accordingly, a push notification is provided at node 614 and a count is increased for a notification icon at node 616.

At node 618, a notification update should be generated based on event A. Accordingly, a notification update is sent at node 620 and the notification is moved to a top of a notification list at node 622. At node 624, no push notification is sent and at node 626 a count is not increased for a notification icon.

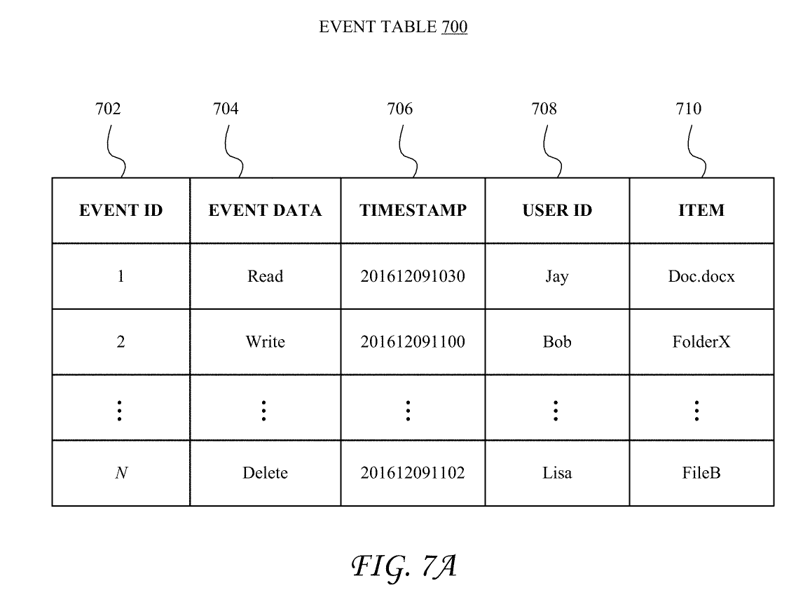

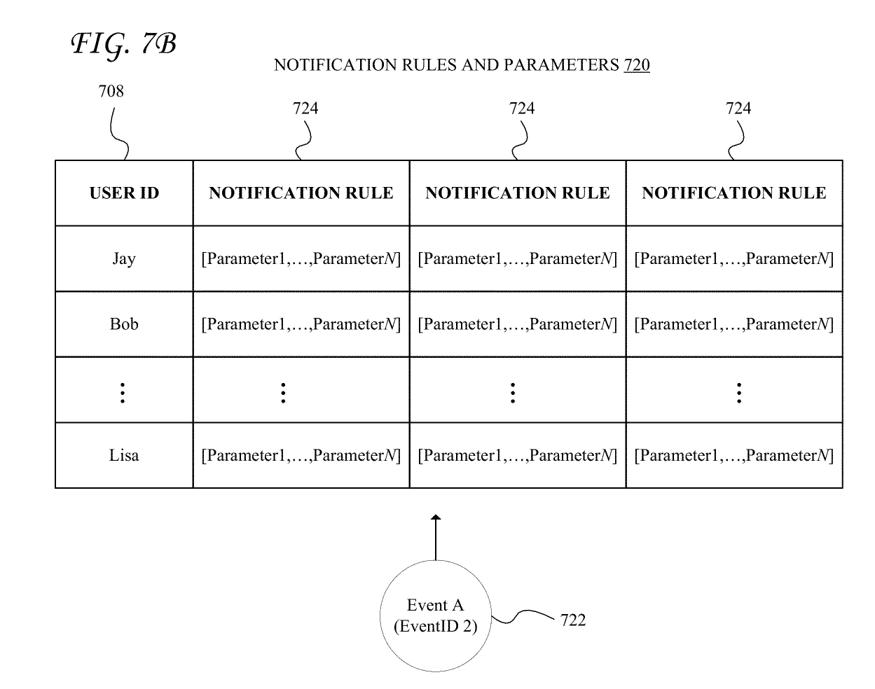

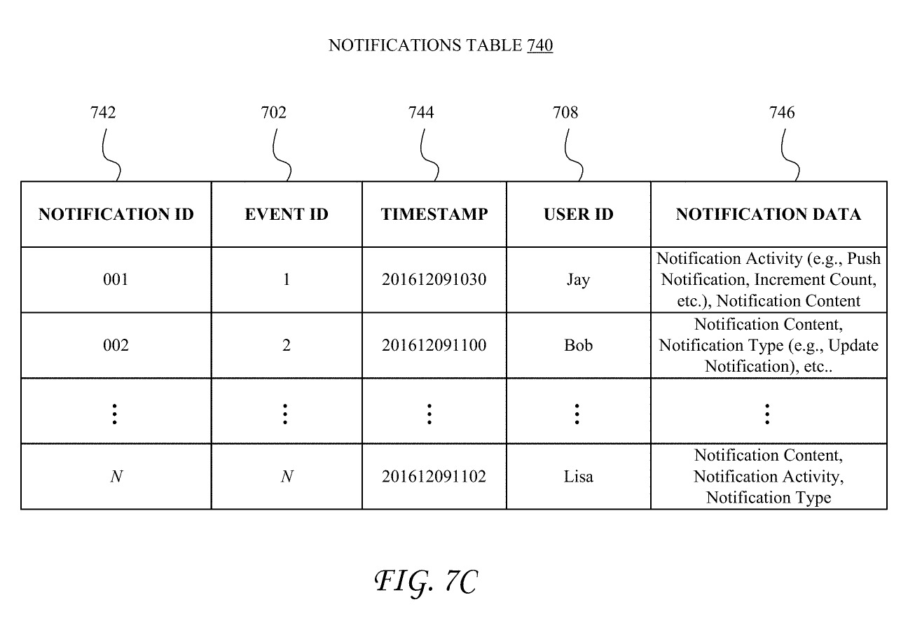

FIG. 7A illustrates an example table of events which can be used to track events, including notification and triggering events. In this example, event table 700 can include event identifiers 702, which can uniquely identify respective events; event data 704, which can define the respective events; timestamps 706 which can define a time when the respective events occurred or where received; user identifiers 708 which can provide the user identifiers associated with the respective events, and items 710 can identify the content items associated with the respective events.

FIG. 7B illustrates an example table of notification rules and parameters. In this example, notification rules and parameters table 720 can store notification rules 724 for user identifiers 708. User identifiers 708 can identify users and/or user accounts registered with content management system 110. Notification rules 724 can define one or more parameters for determining when to generate a notification, what type of notification to generate, what notification activity to perform, etc. For example, notification rules 724 can define triggers for notifications, such as content items (e.g., specific files, folders, etc.) for which a user wishes to receive notifications, events or operations (e.g., read, edit, delete, add, share, etc.) for which the user wishes to receive notifications, user accounts which the user wants to used to filter or trigger notifications, etc.

The amount of parameters and/or number of notification rules 724 can vary for different user accounts. For example, a user account may include no notification rules, another user account may include only a single notification rule, and yet another user account may include a large number of notification rules. Moreover, notification rules 724 and/or parameters defined by notification rules 724 can be defined by a user and/or programed for the user. Notification rules 724 can include general rules, custom rules, variable or conditional rules, dynamic rules, user-specific rules, device-specific rules, content-specific rules, group-specific rules, location-based rules, etc.

Notification rules and parameters table 720 can be used to determine what, if any, notification activity should be generated in response to an event. For example, when event 722 is detected, notification rules and parameters table 720 can be consulted to determine what, if any, notification activity should be generated for event 722 for user identifiers 708.

FIG. 7C illustrates an example table of notifications which content management system 110 can use to track and/or manage notifications. In this example, notifications table 740 can include notification identifiers 742, event identifiers 702, timestamps 744, user identifiers 708, and notification data 746. Notifications table 740 can thus map specific notifications with specific events and user accounts. For example, notifications table 740 can map notification ID 002 to event ID 2 and user ID Bob, to indicate that notification ID 002 was generated for event ID 2 associated with user ID Bob, and include other information about this mapped notification, such as timestamp information and notification data.

Notification data 746 can specify the content of the notification, notification activity associated with the notification (e.g., push notification, increment notification count, generate alert, generate additional messages or notifications, generate prompt(s), modify notification information or lists, etc.), notification type, such as whether the notification is an update notification, a new notification, a push notification, a tray notification, a notification alert, etc.

Information in notifications table 740 can be used to manage and/or update notifications. For example, if an event is detected and compared with notifications table 740, content management system 110 can determine whether a notification already exists and should be updated in response to the event, or whether a new notification should be generated in response to the event. To illustrate, if content management system 110 detects event 722 in FIG. 7B, content management system 110 can compare event 722, including information about event 722 such as a content item and/or user account associated with event 722, with events corresponding to event identifiers 702, to determine if a notification has already been generated for event 722, a content item associated with event 722, a user account associated with activity from event 722, etc. Content management system 110 can make this comparison to determine if a new notification should be generated for event 722 or a previous notification relating to event 722 can be updated.

When making such a comparison between an event detected and events associated with previous notifications (e.g., events corresponding to notification identifiers 742 in notifications table 740), content management system 110 can obtain information about the events associated with previous notifications (e.g., events corresponding to event identifiers 702 in notifications table 740) from one or more sources, such as notifications table 740, event table 700, and/or notification rules and parameters table 720.

For example, content management system 110 can use event identifiers 702 to extract event information from event table 700, such as items 710, user identifiers 708, event data 704, etc. To illustrate, content management system 110 can identify event ID 2 from event identifiers 702 in notifications table 740, search event ID 2 within event identifiers 702 in event table 700, and determine that event ID 2 is a write event by Bob associated with Folder X. Content management system 110 can then compare this information with information about event 722 to determine whether to issue a notification update or a new notification. For example, if event 722 is related to Folder X, content management system 110 may determine that a notification for Folder X has already been provided to user account Bob based on the correlation of event ID 2 and notification ID 002 in notifications table 740 with Folder X from item 710 and event ID 2 in event table 700.

Event table 700, notification rules and parameters table 720, and notifications table 740 are provided as non-limiting examples of stored and lookup information for clarity and explanation. However, other configurations are also contemplated herein. For example, in some cases, information from event table 700, notification rules and parameters table 720, and/or notifications table 740 can be included in a single table or database, or may be divided, stored, and/or organized in other ways. Moreover, information from event table 700, notification rules and parameters table 720, and/or notifications table 740 may be linked or related in different ways. For example, event table 700, notification rules and parameters table 720, and/or notifications table 740 can be linked via primary keys, secondary keys, and/or foreign keys.

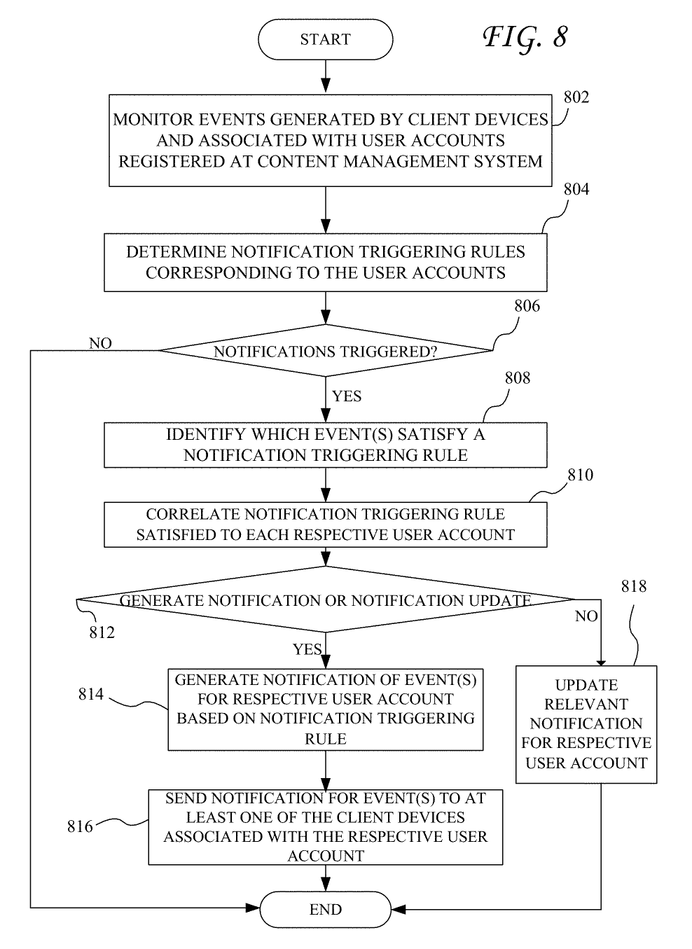

Having disclosed various system components and concepts, the disclosure now turns to the example flowchart shown in FIG. 8. For the sake of clarity, the flowchart is described in terms of content management system 110, shown in FIGS. 1A and 1B, configured to perform the various steps in the flowchart. The steps outlined herein are exemplary and can be implemented in any combination thereof, including combinations that exclude, add, or modify certain steps.

At step 802, content management system 110 can monitor events generated by client devices 150 and associated with user accounts registered at content management system 110. The events can include interactions between client devices 150 and content items accessed from client devices 150 via the user accounts. The content items can be stored at content management system 110 and accessed from client devices 150 via the user accounts registered at content management system 110, and/or stored at client devices 150 but accessed from client devices 150 via the user accounts and/or synchronized from client devices 150 to content management system 110 via the user accounts.

In some examples, content management system 110 can receive messages or notifications from client devices 150 reporting events at client devices 150. The events can involve content items at content management system 110 and/or stored at client devices 150 but accessed from client devices 150 via the user accounts and/or client application 152.

As previously explained, each client device 150 can monitor events, such as content item operations and interactions, at the respective client device and send event data 180 to content management system 110, which can include reports or notifications of events at the respective client device. Content management system 110 can store event data 180 and/or any event information obtained from each client device 150, and monitor event data 180 as reported or received from each client device 150. For example, as content management system 110 receives or stores event data 180, it can analyze the data to identify events at each client device 150 which correlate to the user accounts registered at content management system 110, content item(s) at content management system 110, and/or client application 152.

Events reported in event data 180 can be specific to events associated with client application 152. Thus, content management system 110 can track events at each client device 150 which correlate to client application 152. However, the events reported in event data 180 can also include events associated with other applications at client device 150, such as a browser application at client device 150 for browsing the Internet.

In some cases, content management system 110 can also track events at content management system 110 associated with each client device 150. For example, when each client device 150 interacts with content items at content management system 110, content management system 110 can track such interactions to identify events related to each client device 150 and/or particular user accounts associated with the events.

However, event data 180 from client devices can allow content management system 110 to track events occurring locally at each of the client devices and, in some cases, may allow content management system 110 to detect the local events from the client devices in real time or near real time. As further explained below, this can allow content management system 110 to generate notifications relating to local events at each client device 150, and provide the notifications to client devices as the local events occur at a particular client device or close in time.

Continuing with step 804, content management system 110 can determine notification triggering rules corresponding to the user accounts and, at step 806, determine if any of the monitored events trigger a notification triggering rule for any of the user accounts. Thus, content management system 110 can determine if one or more notifications should be generated for any of the user accounts based on the monitored events.

At step 808, if any notification triggering rule is triggered by any of the monitored events, content management system 110 can identify which events satisfy a notification triggering rule. Content management system 110 can identify which events satisfy a notification triggering rule to determine which events should result in a notification and/or what notifications should be generated.

At step 810, content management system 110 can correlate the notification triggering rule satisfied to the respective user account(s) associated with the notification triggering rule. This correlation can help content management system 110 identify which user accounts should receive a notification for a particular event. For example, user accounts can have their own respective notification triggering rules. Accordingly, some user accounts may have some notification triggering rules in common but may also have one or more differing notification triggering rules. User accounts can thus have customized notification rules and preferences and receive a customized notification experience.

As a result, content management system 110 can make individual decisions for each user account regarding whether that user account should receive a notification based on a particular event and which client device 150 should receive a notification generated for a user account. Depending on the respective notification triggering rules for the various user accounts, content management system 110 may send a notification to a single user account or multiple user accounts. For each event detected, content management system 110 may thus determine which if any of the user accounts should receive a notification for that event, and may only send a notification associated with the event for those user accounts, if any, which have triggering rules that instruct content management system 110 to generate and/or send a notification for that particular event.

By correlating at step 810 the notification triggering rule satisfied to the respective user account(s) associated with the notification triggering rule, content management system 110 can specifically determine which user accounts should receive a notification or notification activity for the event(s) identified at step 808. Thus, steps 802 through 810 allow content management system 110 to identify events and decide for each event which, if any, user accounts should receive a notification or notification activity. This can essentially allow content management system 110 to make customized and individual notification determinations for each user account and monitored event.

In addition, the correlation at step 810 can help content management system 110 determine which specific client devices should receive a particular notification or notification update. As will be further explained with respect to steps 816 and 818, content management system 110 can send notifications and/or provide notification updates to specific client devices for associated user accounts which content management system 110 determines should receive those notifications and/or notification updates. By correlating a notification triggering rule with one or more associated user accounts, content management system 110 can identify not only which user accounts should receive notification activity (e.g., a notification, notification update, etc.), but also where it should send the notification activity. For example, knowing which user accounts should receive a notification can help content management system 110 identify which client devices to send the notification to. To illustrate, content management system 110 may have a profile or other data which associates one or more specific client devices to a particular user account.

Thus, if content management system 110 determines that the particular user account should receive a notification, it can send broadcast the notification to the one or more specific client devices. Such a subset of the one or more specific client devices can be selected based on, for example, current user account activity (e.g., which client device(s) are authenticated via the particular user account), historical user account activity (e.g., which client device(s) are typically used by this particular user account around this time in the day, which client device(s) the particular user account has been using more frequently in the last X amount of time, which client device(s) is most frequently used by this particular user account, which client device(s) is the “main” device of the particular user account, which client device(s) is the “home” or “work” device for this particular user account, etc.), user account preference (e.g., a user profile preference indicating which client device should receive notifications).

At step 812, content management system 110 can determine whether the respective user account(s) should receive a new notification or a notification update. As previously explained, content management system 110 can determine if a user account should receive a new notification or a notification update based on whether the user account has previously received, or currently has, a relevant notification which can be updated. If the user has a relevant notification, content management system 110 can generate a notification update to update the relevant notification. On the other hand, if the user does not have a sufficiently-relevant notification, content management system 110 can generate a new notification for the respective user account.

Content management system 110 can determine if the user account has previously received, or currently has, a relevant notification based on the notifications previously generated for the user account by content management system 110. For example, content management system 110 can compare the event or events that satisfied one or more of the user account's notification triggering rules with notifications previously sent to, and/or generated for, the user account in order to determine whether user account has a relevant notification which can be updated in order to avoid sending a new notification.

At step 818, if content management system 110 determines that it should generate a notification update, content management system 110 can generate the notification update and update a relevant notification based on the event or events.

At step 818, if content management system 110 determines that it should generate a notification (e.g., new notification), content management system 110 can generate the notification of the event or events based on the satisfied notification triggering rule. Based on the satisfied notification triggering rule and/or the event or events, the notification can include one or more notification activities, such as sending a push notification and updating a notification counter, and/or one or more types of notifications, such as a push notification, a tray notification, an email notification, etc.

At step 816, content management system 110 can send the notification to one or more client devices associated with the respective user account. Content management system 110 can identify one or more client devices correlated to the respective user account based on user account information, usage or activity information, authentication information, etc. Content management system 110 can thus send the notification to the specific client device(s) associated with the respective user account.

Content management system 110 can send the notification to client application 152 at each client device 150 and/or another application, such as a browser application for browsing web pages. In some cases, content management system 110 can send the notification at step 816 or notification update at step 818 to a browser application at the particular client device. For example, as previously explained, each client device 150 can access content management system 110 via a web browser. Accordingly, content management system 110 can send the notification or notification update to the web browser at a client device for presentation at the web browser when the client device accesses web content on content management system 110 from the web browser through the respective user account. In this example, the notification or notification update can be provided in a web page accessed by the client device from the web browser.

Thus, content management system 110 can send different notifications to different client devices based on local events at one or more client devices, and the notifications can be provided to the client devices via different applications, such as client application 152 and a browser application, depending on which application is used at the client devices to access the content item(s) related to the events.

For example, assume that Bob accesses a content item via client application 152 at Bob's client device, and Lisa and Jay access the content item or a version of the content item from a web browser at their respective client devices. Assume that Bob then edits the content item from Bob's client device. Bob's client device can detect the edit event and report it to content management system 110. Content management system 110 can thus detect the edit event even if the edit event is a local event at Bob's device, and even if the edit event is made to a local version of the content item stored at Bob's client device. Assuming the edit event satisfies a notification triggering rule associated with Lisa's account, content management system 110 can then send a notification about the edit event to the web browser at Lisa's respective client device through Lisa's user account. Thus, as Lisa accesses the content item through the web browser at her respective client device, Lisa can receive a notification or notification update based on the edit event at Bob's client device. At the same time, Jay can opt not to receive the notification by configuring Jay's notification triggering rules to ensure that the edit event does not trigger a notification for Jay.

In this way, content management system 110 can detect an event from a user account, client device, and software application, and intelligently send notifications of the event to other user accounts and client devices, through the same software application and/or a different software application.

FIG. 9 illustrates an example computing system architecture 900 wherein the components of the system are in communication with each other using a connection 905. Connection 905 can be a physical connection via a bus, or direct connection into processor 910 such as in a chipset architecture. Connection 905 can also be a virtual connection, networked connection, or logical connection.

In some embodiments 900 is a distributed system, wherein the functions described with respect to the components herein can be distributed within a datacenter, multiple datacenters, geographically, etc. In some embodiments, one or more of the described system components represents many such components each performing some or all of the function for which the component is described. In some embodiments, the components described herein can be physical or virtual devices.

Example system 900 includes at least one processing unit (CPU or processor) 910 and a connection 905 that couples various system components including the system memory 915, such as read only memory (ROM) and random access memory (RAM) to the processor 910. The system 900 can include a cache of high-speed memory connected directly with, in close proximity to, or integrated as part of the processor 910.

The processor 910 can include any general purpose processor and a hardware service or software service, such as service 1 932, service 2 934, and service 3 936 stored in storage device 930, configured to control the processor 910 as well as a special-purpose processor where software instructions are incorporated into the actual processor design. The processor 910 may essentially be a completely self-contained computing system, containing multiple cores or processors, a bus, memory controller, cache, etc. A multi-core processor may be symmetric or asymmetric.

To enable user interaction with the computing device 900, an input device 945 can represent any number of input mechanisms, such as a microphone for speech, a touch-sensitive screen for gesture or graphical input, keyboard, mouse, motion input, speech and so forth. An output device 935 can also be one or more of a number of output mechanisms known to those of skill in the art. In some instances, multimodal systems can enable a user to provide multiple types of input to communicate with the computing device 900. The communications interface 940 can generally govern and manage the user input and system output. There is no restriction on operating on any particular hardware arrangement and therefore the basic features here may easily be substituted for improved hardware or firmware arrangements as they are developed.

Storage device 930 can be a non-volatile memory and can be a hard disk or other types of computer readable media which can store data that are accessible by a computer, such as magnetic cassettes, flash memory cards, solid state memory devices, digital versatile disks, cartridges, random access memories (RAMs) 925, read only memory (ROM) 920, and hybrids thereof.

The storage device 930 can include software services, servers, services, etc., that when the code that defines such software is executed by the processor 910, it causes the system to perform a function. In some embodiments, a hardware service that performs a particular function can include the software component stored in a computer-readable medium in connection with the necessary hardware components, such as the processor 910, bus 905, output device 935, and so forth, to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

As used herein, claim language reciting “at least one of” a first item “and” a second item indicates that the first item, the second item, or both the first and second item satisfy the claim. For example, claim language reciting “at least one of A and B” indicates that either a set of A or B (e.g., A only or B only) or a set of A and B (e.g., both A and B) can satisfy the claim.

What is claimed is:

1. A computer-implemented method comprising:
monitoring, via a content management system, events generated by client devices and associated with user accounts registered at the content management system;
determining, via the content management system, notification triggering rules corresponding to the user accounts;
identifying, via the content management system, one or more events that satisfy a respective notification triggering rule from the notification triggering rules;
correlating, via the content management system, the respective notification triggering rule to a respective user account from the user accounts to yield a user account and triggering rule correlation;
based on the user account and triggering rule correlation, generating, via the content management system, one or more notifications for the one or more events; and
sending, via the content management system, the one or more notifications to at least one of the client devices associated with the respective user account.

2. The computer-implemented method of claim 1, wherein the events comprise local events at the client devices generated by the user accounts, and wherein monitoring the events comprises receiving event data identifying the events from the client devices.

3. The computer-implemented method of claim 2, wherein the event data comprises a respective user account identifier, a respective content item identifier, and a respective event identifier.

4. The computer-implemented method of claim 3, wherein a respective event identified by the respective event identifier comprises at least one of a content add event, a content remove event, a content share event, and a content edit event.

5. The computer-implemented method of claim 1, further comprising:
receiving, from one or more of the user accounts, one or more notification preferences for one or more respective content items associated with the one or more of the user accounts; and
associating one or more respective triggering rules with the one or more of the user accounts, the one or more respective triggering rules being based on the one or more notification preferences.

6. The computer-implemented method of claim 1, further comprising:
for each notification from the one or more notifications sent, tracking which respective user account is associated with the notification; and
prior to sending a notification to a particular user account, determining, based on the tracking, whether the particular user account is associated with a previous notification related to at least one of the notification, an event associated with the notification, and a content item associated with the notification.

7. The computer-implemented method of claim 6, further comprising:
when the particular user account is associated with the previous notification, updating the previous notification for the particular user account based on content associated with the notification instead of sending the notification as a new notification; and
when the particular user account is not associated with the previous notification, sending the notification to the particular user account as a new notification.

8. The computer-implemented method of claim 1, further comprising:
mapping a respective event identifier corresponding to the one or more events; and
prior to sending a new notification to a particular user account, determining, based on the mapping, whether a first content item associated with a first respective event from the one or more events matches a second content item associated with a second respective event associated with a previous notification to the particular user account.

9. The computer-implemented method of claim 8, further comprising:
when the first content item associated with the first respective event from the one or more events matches the second content item associated with the second respective event associated with the previous notification, determining that the new notification is to be provided as an update to the previous notification.

10. The computer-implemented method of claim 1, wherein at least one of the one or more events is generated at a respective client device via a client application associated with the content management system, and wherein a respective one of the one or more notifications associated with the at least one of the one or more events is sent to a browser application at a different client device.

11. The computer-implemented method of claim 1, wherein at least a portion of the events comprises an interaction with a content item stored at a respective client device having a synchronized copy also stored at the content management system, and wherein the synchronized copy is associated with a plurality of the user accounts.

12. A non-transitory computer readable medium comprising:
instructions stored therein which, when executed by a content management system, cause the content management system to:
monitor events generated by client devices and associated with user accounts registered at the content management system;
determine notification triggering rules corresponding to the user accounts;
identify one or more events that satisfy a respective notification triggering rule from the notification triggering rules;
correlate the respective notification triggering rule to a respective user account from the user accounts to yield a user account and triggering rule correlation;
based on the user account and triggering rule correlation, generate one or more notifications for the one or more events; and
send the one or more notifications to at least one of the client devices associated with the respective user account.

13. The non-transitory computer readable medium of claim 12, wherein at least a portion of the events comprises an interaction with a content item stored at a respective client device having a synchronized copy also stored at the content management system, and wherein the synchronized copy is associated with a plurality of the user accounts.

14. The non-transitory computer readable medium of claim 12, wherein the events comprise local events at the client devices generated by the user accounts, wherein monitoring the events comprises receiving event data identifying the events from the client devices.

15. The non-transitory computer readable medium of claim 14, wherein the event data comprises a respective user account identifier, a respective content item identifier, and a respective event identifier.

16. The non-transitory computer readable medium of claim 12, storing additional instructions stored therein which, when executed by the content management system, cause the content management system to:
receive, from one or more of the user accounts, one or more notification preferences for one or more respective content items associated with the one or more of the user accounts; and
associate one or more respective triggering rules with the one or more of the user accounts, the one or more respective triggering rules being based on the one or more notification preferences.

17. A content management system comprising:
one or more processors; and
at least one computer-readable storage medium having stored therein instructions which, when executed by the one or more processors, cause the content management system to:
monitor events generated by client devices and associated with user accounts registered at the content management system;
determine notification triggering rules corresponding to the user accounts;
identify one or more events that satisfy a respective notification triggering rule from the notification triggering rules;
correlate the respective notification triggering rule to a respective user account from the user accounts to yield a user account and triggering rule correlation;
based on the user account and triggering rule correlation, generate one or more notifications for the one or more events; and
send the one or more notifications to at least one of the client devices associated with the respective user account.

18. The content management system of claim 17, wherein at least a portion of the events comprises an interaction with a content item stored at a respective client device having a synchronized copy also stored at the content management system, and wherein the synchronized copy is associated with a plurality of the user accounts.

19. The content management system of claim 17, wherein at least one of the one or more events is generated at a respective client device via a client application associated with the content management system, and wherein a respective one of the one or more notifications associated with the at least one of the one or more events is sent to a browser application at a different client device.

20. The content management system of claim 17, the at least one computer-readable storage medium storing additional instructions which, when executed by the one or more processors, cause the content management system to:
receive, from one or more of the user accounts, one or more notification preferences for one or more respective content items associated with the one or more of the user accounts, wherein the one or more notification preferences comprise a request to receive notifications for respective events associated with the one or more respective content items; and
associate one or more respective triggering rules with the one or more of the user accounts, the one or more respective triggering rules being based on the one or more notification preferences.
